(19) United States
(12) Patent Application Publication
(10) Pub. No.: US 2026/0218666 A1
(43) Pub. Date: Jul. 30, 2026

(54) JET DEFLECTION MODULE FOR A THRUST REVERSER OF AN AIRCRAFT TURBINE ENGINE

(71) Applicant: SAFRAN NACELLES, Gonfreville-L'Orcher (FR)

(72) Inventors: Mickael SOREL, Moissy-Cramayel (FR); Jean-Baptiste DELARUE, Moissy-Cramayel (FR); Laurent Georges VALLEROY, Moissy-Cramayel (FR); Bertrand Leon Marie DESJOYEAUX, Moissy-Cramayel (FR)

(21) Appl. No.: 19/145,459

(22) PCT Filed: Jan. 8, 2024
(86) PCT No.: PCT/FR2024/050013

§ 371 Date: Jul. 2, 2025

(30) Foreign Application Priority Data
Jan. 16, 2023 (FR) FR2300389

(51) Int. Cl. F02K 1/72; B64C 25/00; B64D 27/16

(52) U.S. Cl. CPC F02K 1/72; B64C 25/001; B64D 27/16

(57) ABSTRACT

A jet deflection module for a thrust reverser of an aircraft turbine engine, this module extending in a surface and including longitudinal members which are spaced apart from one another and parallel to one another; at least one deflection element which extends between the longitudinal members and which is connected to these longitudinal members; and two attachment profiles, front and rear, respectively, which are connected to the longitudinal members, these two profiles forming, with two of these longitudinal members, a peripheral contour of the module, wherein a first of the attachment profiles includes a plurality of hooks at a distance from one another, each of these hooks including at least one opening oriented perpendicularly to the surface and additionally a bearing surface parallel to this surface.

### TECHNICAL FIELD OF THE INVENTION

The invention relates to the field of thrust reversers for aircraft turbomachines, and in particular to a jet deflection module for such a thrust reverser. This jet deflection module is, for example, a grid.

### TECHNICAL BACKGROUND

The technical background comprises in particular the documents FR-A1-2 938 878, FR-A1-2 954 410, FR-A1-3 069 891, FR-A1-3 076 865, US-A1-2017/226962, EP-A1-3 181 881 and US-A1-2017/98869.

The thrust reversers are now widely used in aircraft nacelles, particularly in the nacelles housing a turbomachine such as a dual flow turbomachine. In a known way, such a turbojet engine generates, by means of the blades of a rotating fan, a hot air flow (referred to as primary flow) coming from a combustion chamber, and a cold air flow (referred to as secondary flow) which circulates outside the turbojet engine through an annular channel, formed between a fairing of the turbojet engine and an internal wall of the nacelle. The two air flows are then ejected out of the turbojet engine through the rear of the nacelle and thus generate a thrust.

In such a configuration, the role of a thrust reverser is, during a landing phase of the aircraft, to improve its braking capacity on the ground by redirecting forward at least one portion of the thrust generated by the turbojet engine. In particular, when the thrust reverser is in action, it obstructs the annular channel of the cold air flow (i.e., the secondary flow) and directs this flow towards the front of the nacelle, thus generating a counterthrust.

The means implemented to redirect the flow of cold air vary according to the type of reverser. However, in general, the structure of a thrust reverser comprises one or more movable covers that can be moved between, on the one hand, a deployed position (also known as the thrust reversal position) in which they open a passage in the nacelle for the diverted flow, and on the other hand, a retracted position (also known as the direct jet position) in which they close this passage. The covers can thus be used to activate other deflection means such as flaps. In this case, the flaps, activated by the movement of the movable covers, obstruct, at least in part, the vein in which the secondary flow circulates.

In addition, in the case of a thrust reverser with deflection grids, the air flow is then redirected by a jet reversal ring consisting of thrust reversal modules installed circumferentially around the thrust reversal ring and generally made of jet deflection grids. However, the grids are not the only options for jet diversion.

A thrust reverser 10 is illustrated in FIGS. 1 and 2. This reverser 10 is of the grid or cascade reverser type.

This type of reverser 10 comprises at least one cover 12 which is movable relative to a fixed structure 14 comprising an upstream annular frame 16, the cover 12 having an outer wall 18 and an internal wall 20 intended to define, in a direct jet position of the turbojet engine (FIG. 1), an external wall of the annular duct 22 in which the secondary flow F11 flows.

The reverser 10 also comprises flaps 24 mounted in an articulated manner on the movable cover 12 and actuated by connecting rods 26 when the movable cover 12 is moved downstream, so that, in a thrust reversal position (FIG. 2), each flap 24 comprises a zone extending into the annular duct 22 so as to divert at least part of the secondary flow F11 out of the duct 22.

In the case of this type of reverser 10, the secondary flow F11 is redirected by deflection grids 26, the mobile cover 12 having only a simple sliding function aimed at uncovering or covering these grids 26, the translation of the mobile cover 12 taking place along a longitudinal axis substantially parallel to the axis of the nacelle and of the reverser 10.

A housing is provided in the cover 12 to house the grids 26 when the reverser 10 is not actuated, i.e., in the direct jet position, as shown in FIG. 1.

The grids 26 are arranged adjacent to one another in an annular zone surrounding the annular duct 22, the grids 26 being arranged edge to edge with the smallest possible gap between them. In this way, the vast majority of the secondary flow F11 deflected by the flaps 24 passes through the grids 26.

The thrust reverser 10 also comprises means for moving and guiding the mobile covers 12, which generally comprise actuators 28, each of which has an elongated shape and extends parallel to the axis of the thrust reverser 10. Each actuator 28 has an upstream end 28a fastened to the fixed structure 14 comprising the frame 16, and a downstream end 28b which is fastened to the cover 12.

The grids 26 are generally fastened by their upstream ends to the front frame 16 and by their downstream ends to a downstream ring frame 30.

A thrust reverser 10 grid 26 is shown in FIG. 3. This grid 26 extends mainly across a surface P, which may be flat, curved or chevron-shaped. This surface is intended to be crossed by the air flow to be diverted.

The grid 26 comprises:
spars 32 which are spaced apart and parallel to each other,
vanes 34 extending between the spars 32 and connected to these spars 32, these vanes 34 being perpendicular to the spars 32, and
two fastening profiles, front 36 and rear 38 respectively, which are connected to the spars 32 and which are perpendicular to these spars 32, these two profiles 36, 38 forming with two of the spars 32 a frame or peripheral contour of the grid 26.

In the current technique, each of the profiles 36, 38 comprises or forms a flange 40 for fastening to the corresponding frame 16, 30. As illustrated in FIGS. 3 to 5, each flange 40 can extend into surface P and can define a flat bearing surface 42 which is intended to bear on the corresponding frame 16, 30. Alternatively, each flange 40 can be inclined with respect to this surface P or can have a folded shape, for example in the form of a dihedron or chevron, or a curved shape in the form of a portion of a cylinder, etc. The frames 16, 30 have complementary shapes to accommodate these flanges. The flange 40 comprises orifices 44 aligned with orifices 46 in the frame 16, 30, these orifices 44, 46 being traversed by screws 48 for fastening the grid 26 to the frame 16, 30.

However, this technology is not entirely satisfactory, as it has its drawbacks. The flanges 40 are relatively bulky and result in an increase in the length of the grid 26 or a reduction in the useful surface area of the grid 26 occupied by the spars 32 and vanes 34. In addition, the connections of the flanges 40 to the rest of the grid 26 are stress concentration zones which must be taken into account when defining the grid 26 and which may result in oversizing in these zones, leading to an increase in the mass of the grid 26.

The invention offers a simple, effective and economical solution to at least some of the problems of current technology.

The invention is not limited to a thrust reverser or jet deflection grid but extends to any jet deflection module. This module can be applied to a grid, a thrust reverser ring made up of jet deflection modules arranged between a circumferential front frame and a circumferential rear frame, etc.

### SUMMARY OF THE INVENTION

According to a first aspect, the invention relates to a jet deflection module for a thrust reverser of an aircraft turbomachine, this module extending in a surface and comprising:
spars which are spaced apart and parallel to each other,
at least one deflection element which extends between the spars and connected to these spars,
two fastening profiles, front and rear respectively, which are connected to the spars and which, together with two of these spars, form a peripheral contour of the module,
characterized in that a first of the fastening profiles comprises at least one extra thickness in a direction parallel to said surface, said at least one extra thickness comprising at least one tapped hole which is oriented perpendicularly to this surface.

The advantages of the invention include simplification of at least one of the fastening profiles by eliminating its flange. The removal of the flange reduces the length of the module and its overall dimensions in this direction. The rest of the module, which represents the useful and functional part of the module, is not impacted, which is also advantageous. The module is also easy to assemble and dismantle.

The jet deflection module according to the invention may comprise one or more of the following characteristics, taken in isolation from each other or in combination with each other:
the module covers said surface;
said surface is flat, curved, dihedral or chevron-shaped;
said deflection element is a vane;
said deflection element is soft or flexible, or on the contrary rigid;
said deflection element is a membrane;
said at least one extra thickness is oriented in a direction parallel to the spars;
the spars are straight or curved;
the fastening profiles are perpendicular to the spars;
the or each tapped hole is formed by an insert mounted in an orifice in the first profile, this orifice being oriented perpendicularly to said surface;
said first profile comprises a single extra thickness extending over at least 80% of a length of this first profile;
said first profile comprises several thicker sections spaced apart from one another and each comprising a tapped hole;
said first profile comprises a first side located inside said contour and a second opposite side located outside this contour, the first side comprising pressure side surfaces;
said pressure side surfaces are located opposite the suction side of adjacent vanes and are separated from each other by spars;
the second side comprises said single extra thickness and comprises a flat surface which extends over at least 80% of the length of the first profile and which is perpendicular to said surface, this flat surface extending between two other flat surfaces, respectively upper and lower, which extend over at least 80% of the length of the first profile and which are parallel to each other and to said surface;
said at least one tapped hole opens onto the upper or lower flat surface, which is configured to form a bearing surface for the module;
said or each tapped hole or said or each orifice opens onto one of said pressure side surfaces;
the second side comprises said extra thickness formed by bosses;
said tapped holes open into surfaces of the bosses which are aligned with each other and with a surface of the first profile which extends over at least 80% of a length of this profile and which is configured to form a bearing surface of the module;
said at least one insert is fully housed in its mounting orifice.
the inserts are tubular;
the or each hole or insert has a length which represents 20 to 50% of a thickness of the module measured in a direction perpendicular to said surface;
said first profile is the rear profile of the module;
the module is made of composite material;
the module is made by draping folds (layers of fibres) and then injecting polymerisable resin to embed and solidify them; however, this type of construction is not restrictive, and the module could be made by any type of manufacturing method, for example by machining, casting, additive manufacturing, thermocompression, injection, etc.;
the vanes each have an aerodynamic profile and comprise a pressure side and a suction side;
the module is a grid comprising several spars and vanes which extend between the spars, and which are connected to the spars, these vanes being perpendicular to the spars.

The present invention also relates to a thrust reverser for an aircraft turbomachine, comprising at least one module as described above.

Advantageously, the reverser has a generally annular shape around a central axis and comprises several modules distributed around this axis, each of these modules bearing radially outwards on an annular frame which comprises orifices which are aligned with the tapped holes, and through which pass screws screwed from the outside into these tapped holes.

The present invention also relates to an aircraft turbomachine, comprising a thrust reverser or module as described above.

According to a second aspect, the invention relates to a jet deflection module for a thrust reverser of an aircraft turbomachine, this module extending into a surface and comprising:
spars that are spaced apart and parallel to each other,
at least one deflection element extending between the spars and connected to these spars,
two fastening profiles, front and rear respectively, which are connected to the spars and which, together with two of these spars, form a peripheral contour of the module,
characterized in that a first of the fastening profiles comprises at least one hook which comprises at least one opening oriented perpendicularly to said surface, this hook also comprising a bearing surface parallel to this surface.

The advantages of the invention include simplification of at least one of the fastening profiles by eliminating its flange. The removal of the flange reduces the length of the module and its overall dimensions in this direction. The rest of the module, which represents the useful and functional part of the module, is not impacted, which is also advantageous. The module is also easy to assemble and dismantle.

The module according to the invention may comprise one or more of the following characteristics, taken alone or in combination with each other:
the module covers said surface;
said surface is flat, curved, dihedral or chevron-shaped;
said deflection element is a vane;
said deflection element is soft or flexible, or on the contrary rigid;
said first section comprises a single U-shaped hook which extends over at least 80% of a length of said first section;
the spars are straight or curved;
the fastening profiles are perpendicular to the side members;
said at least one hook is U-shaped;
said first profile comprises several hooks, for example U-shaped, at a distance from one another;
the bearing surface and the opening of the or each hook are located on the same end of this hook, or respectively on two opposite ends of this hook;
the or each hook comprises two openings oriented perpendicularly to said surface and in opposite directions;
said first profile comprises a first side located inside said contour and a second opposite side located outside this contour, the first side comprising pressure side surfaces, the second side comprising the hook(s);
said pressure side surfaces are located opposite the suction side of adjacent blades and are separated from each other by spars;
the or each hook comprises a flat surface which is located outside said contour and which is perpendicular to said surface;
the or each hook has a thickness less than that of the module;
said first profile is the rear profile of the module;
the module is made of composite material;
the module is made by draping folds (layers of fibres) and then injecting polymerisable resin to embed the fibres and solidify them;
However, this type of design is not limitative, and the module could be produced by any type of manufacturing method, for example by machining, casting, additive manufacturing, thermocompression, injection, etc.;
the vanes each have an aerodynamic profile, and each comprise a pressure side surface and a suction side surface;
the module is a grid comprising several spars and vanes extending between the spars and connected to the spars, these vanes being perpendicular to the spars.

The invention also relates to an assembly comprising a module as hereinbefore described and at least one link bar for fastening that module, the or each link bar having a general L- or U-shape and being configured to be mounted on the hook of the module.

Advantageously, the or each link bar comprises a rim configured to be engaged in the opening or one of the openings of the hook.

Advantageously, the or each link bar comprises a passage orifice or screw orifice, or carries a screw or threaded rod.

The present invention also relates to a thrust reverser for an aircraft turbomachine, comprising at least one module or assembly as described above.

Advantageously, the reverser has a generally annular shape around a central axis and comprises several modules distributed around this axis, each of these modules bearing radially outwards on an annular frame which comprises passage orifices or screwing in screws or threaded rods.

Advantageously, the frame comprises a rim configured to be engaged in the opening or one of the openings of the hook.

The present invention also relates to an aircraft turbomachine, comprising a module, assembly or thrust reverser as described above.

According to a third aspect, the invention relates to a jet deflection module for a thrust reverser of an aircraft turbomachine, this module extending into a surface and comprising:
spars that are spaced apart and parallel to each other,
at least one deflection element extending between the spars and connected to these spars,
two fastening profiles, one at the front and one at the rear, which are connected to the spars and which, together with two of these spars, form a peripheral contour of the module,
characterized in that a first of the fastening profiles comprises at least two hinge clevises which are parallel to each other and to the spars and which each comprise an orifice, the orifices of the clevises being aligned and defining a pivot axis of the module.

The invention offers advantages including simplification of at least one of the fastening profiles by eliminating its flange. The removal of the flange reduces the length of the module and its overall dimensions in this direction. The rest of the module, which represents the useful and functional part of the module, is not impacted, which is also advantageous. The module according to the invention is also easy to assemble and disassemble.

The module according to the invention may comprise one or more of the following characteristics, taken alone or in combination with each other:
the module covers said surface:
said surface is flat, curved, dihedral or chevron-shaped;
said deflection element is a vane;
said deflection element is soft or flexible, or on the contrary rigid;
the spars are straight or curved;
the fastening profiles are perpendicular to the spars;
the clevises extend in line with the side rail(s);
The number of clevises is between two and eight;
the number of clevises is equal to the number of spars;
the clevises are single-ear or double-ear.
the clevises are formed in one piece with the rest of the module or are added and fastened to the rest of the module;
metal bushings are housed in the orifices in the clevises;
said first profile comprises a first side located inside said contour and a second opposite side located outside this contour, the first side comprising suction sides, the second side comprising the clevises;
said suction side surfaces are located opposite the pressure side of adjacent vanes and are separated from each other by spars;
said first profile is the front profile;
the module is made of composite material;
The module is made by draping layers of fibres and then injecting polymerizable resin to embed and solidify them;
However, this type of design is not limitative and the module could be produced by any type of manufacturing method, for example by machining, casting, additive manufacturing, thermocompression, injection, etc.;
the vanes each have an aerodynamic profile and comprise a pressure side and a suction side;
the module is a grid comprising several spars and vanes extending between the spars and connected to the spars, these vanes being perpendicular to the spars.

The invention also relates to an assembly comprising a module as described above and a hinge fitting for this grid, the fitting comprising clevises configured to be fastened respectively to the clevises of the module.

The present invention also relates to a thrust reverser for an aircraft turbomachine, comprising at least one module or assembly as described above.

Advantageously, the reverser has a generally annular shape around a central axis and comprises several modules distributed around this axis, each of these modules being fastened and articulated to an annular frame by means of its clevises.

Advantageously, the clevises of the module are fastened and articulated to clevises on the frame or on a fitting added and fastened to the frame.

The present invention also relates to an aircraft turbomachine, comprising a module, an assembly or a thrust reverser as described above.

The characteristics of the different aspects of the invention can be combined together, so that the same module can, for example, comprise a first profile according to one aspect of the invention and a second profile according to another aspect of the invention.

### BRIEF DESCRIPTION OF THE FIGURES

The invention will be better understood, and other details, characteristics and advantages of the present invention will become clearer from the following description made by way of non-limiting example and with reference to the attached drawings, wherein:

FIG. 1 is a partial schematic view, in longitudinal section, of a thrust reverser in the direct jet position;

FIG. 2 is a partial schematic view, in longitudinal cross-section, of the thrust reverser of FIG. 1 in the thrust reversal position;

FIG. 3 is a schematic perspective view of a module of a thrust reverser;

FIG. 4 is a schematic partial perspective view of the module shown in FIG. 3, and shows a fastening flange for this module, which is applied and fastened to a frame;

FIG. 5 is a schematic view of the module and frame shown in FIG. 4, the section being taken along line V-V in FIG. 4 and passing through a fastening screw;

FIG. 6 is a schematic partial perspective view of a thrust reverser module, according to one embodiment of the invention;

FIG. 7 is a schematic cross-sectional view of the module and frame shown in FIG. 6, the section being taken along line VII-VII of FIG. 6 and passing through a fastening screw;

FIG. 8 is another schematic sectional view of the module and frame of FIG. 6, the section being taken along line VIII-VIII of FIG. 6 and passing between two adjacent fastening screws;

FIG. 9 is a partial perspective view of a module for a thrust reverser, according to one embodiment of the invention;

FIG. 10 is a schematic perspective and cross-sectional view of the module shown in FIG. 9, the cross-section being along line X-X in FIG. 9 and passing through an insert;

FIG. 11 is a partial perspective view of a module for a thrust reverser, according to another embodiment of the invention.

FIG. 12 is a schematic perspective view of a frame and link bars for fastening the module shown in FIG. 12;

FIG. 13 is a partial schematic cross-section of the module and frame shown in FIGS. 11 and 12;

FIG. 14 is a schematic cross-section of the frame and fastening link bars of FIG. 12;

FIG. 15 is a partial perspective view of a module for a thrust reverser, according to another embodiment of the invention.

FIG. 16 is a schematic perspective view of a frame and a link bar for fastening the module in FIG. 15;

FIG. 17 is a partial schematic cross-section of the module, frame and link bar of FIGS. 15 and 16;

FIG. 18 is a partial perspective view of a module for a thrust reverser, according to another embodiment of the invention.

FIG. 19 is a schematic partial cross-section of the module shown in FIG. 18, associated with a frame and a link bar;

FIGS. 20a-20c are schematic cross-sectional views of several embodiments of a frame and a link bar for fastening a module according to the invention.

FIG. 21 is a partial perspective view of a module for a thrust reverser, according to another embodiment of the invention.

FIG. 22 is a schematic perspective view of a frame for fastening the grid of FIG. 21;

FIG. 23 is a schematic partial sectional view of the module and frame shown in FIGS. 21 and 22;

FIG. 24 is a partial perspective view of a module for a thrust reverser, according to another embodiment of the invention.

FIG. 25 is a partial perspective view of a frame for fastening the module of FIG. 24, and shows a cover for this frame; and

FIG. 26 is a schematic partial perspective view of a module and a frame for fastening this grid module by means of a fastening bracket.

### DETAILED DESCRIPTION OF THE INVENTION

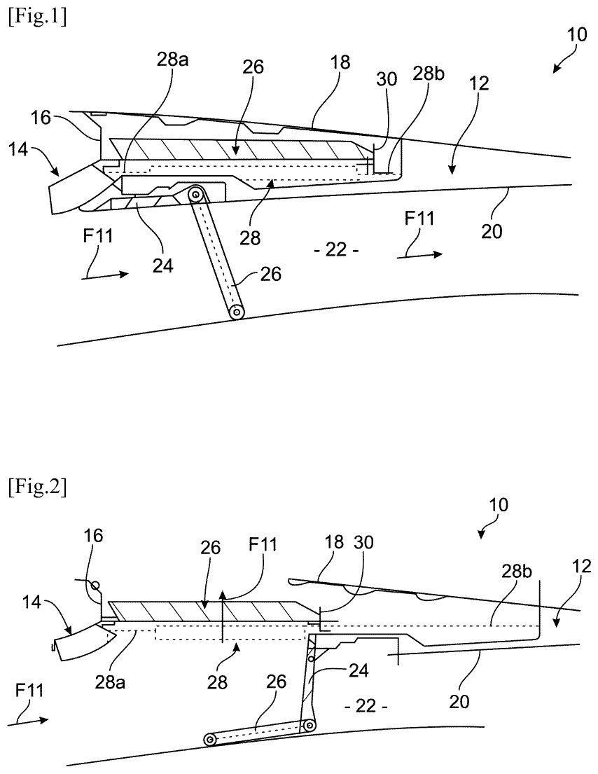

FIGS. 1 to 5 have been described above.

FIG. 6 and following illustrate several embodiments of the invention.

These embodiments relate to particular characteristics of at least one of the profiles 36, 38 of a jet deflection module for a thrust reverser 10. Although the following description focuses on a module in the form of a grid, the invention is not limited to this type of module as mentioned above.

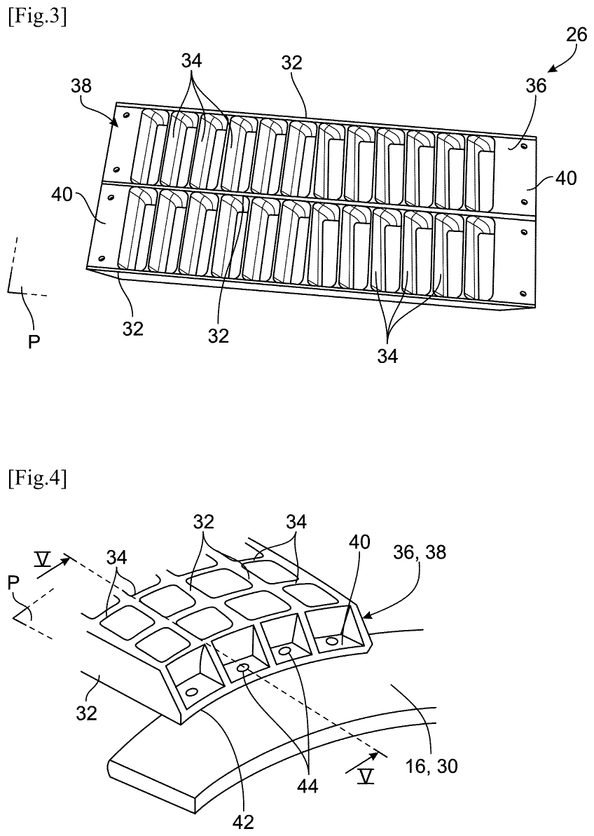

As illustrated in FIG. 3, a module or grid 26 comprises:
(at least two) spars 32 which are spaced apart and parallel to each other,
at least one deflection element 34 extending between the spars 32 and connected to these spars 32; this deflection element or elements are, for example, vanes 34 perpendicular to the spars 32, although this is not limitative, and
two fastening profiles, front 36 and rear 38 respectively, which are connected to the spars 32 and which are perpendicular to these spars 32, these two profiles 36, 38 forming with the spars or with two of these spars 32 a peripheral contour of the grid 26.

The deflection elements 34 may be soft or flexible, or rigid. The soft or flexible deflection elements are membranes, for example.

The spars 32 can be straight or curved, for example.

According to the invention, at least one of the sections 36, 38 of the grid 26 may correspond to one of the sections described below with reference to FIG. 6 and following. For example, the front profile 36 or the rear profile 38 of the grid 26 could correspond to one of these profiles. Alternatively, the front profile could correspond to one of these profiles, and the rear profile 38 could correspond to the same profile or to another of these profiles.

Advantageously, the grid 26 according to the invention comprises a front profile 36 (alternatively rear profile 38) which corresponds to one of the embodiments described below with reference to FIGS. 6 to 20c, and this same grid 26 comprises a rear profile 38 (alternatively front profile 36) which corresponds to one of the embodiments described below with reference to FIGS. 21 to 26.

These embodiments will now be described one after the other.

FIGS. 6 to 8 illustrate a first embodiment in which one of the fastening profiles 36, 38, for example the rear profile 38, comprises at least one thickening 50 wherein threaded holes 51 are formed.

In the example shown, the profile 38 comprises several thickened sections 50 spaced apart from each other and each comprising a tapped hole 51. These tapped holes 51 are oriented perpendicularly to the surface P, which may be flat, curved, dihedral or chevron-shaped as mentioned above. This surface is intended to be crossed by the air flow to be diverted.

The extra thicknesses 50 are oriented in a direction parallel to the surface P, in particular parallel to the spars 32.

Each of the holes 51 can be formed by machining the profile 38 and, for example, threading an orifice 52 in the profile 38. Alternatively, each of the holes 51 is formed by fitting a threaded insert 54 into an orifice 52 in the profile 38.

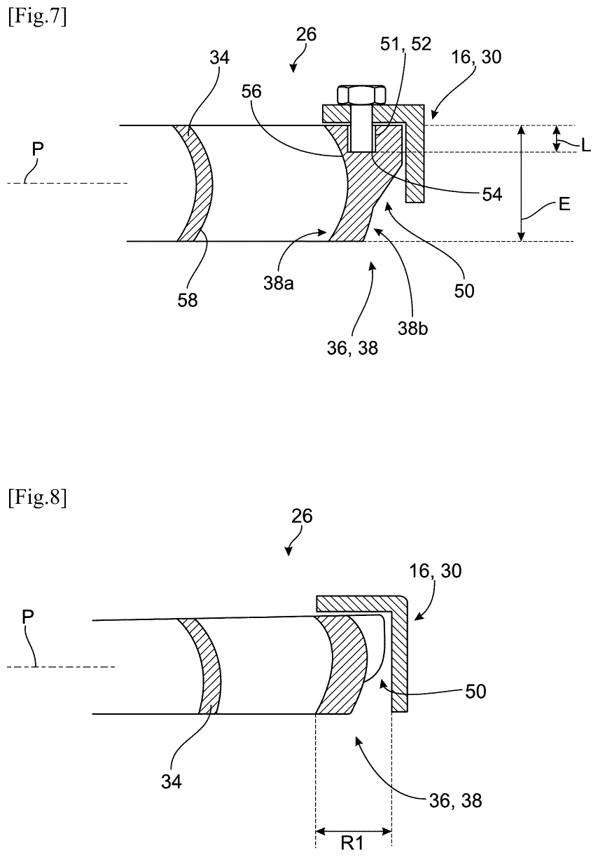

The profile 38 comprises a first side 38a located inside the aforementioned contour and a second opposite side 38b located outside this contour. The first side 38a comprises pressure side surfaces 56 which are located opposite suction side 58 of adjacent vanes 34 and which are separated from each other by spars 32, as can be seen in FIGS. 7 and 8.

It can be seen that the second side 38b comprises the extra thicknesses 50, which are formed by bosses.

The holes 51 or orifices 52 open into surfaces 60 of the bosses which are aligned with each other and with a surface 62 of the profile 38 which extends over at least 80% of a length D of the profile 38, and for example over the entire length of this profile, and which is configured to form a bearing surface for the grid 26 (FIG. 6). This bearing surface is designed to cooperate by bearing with the aforementioned frame 16, 30.

The holes 51 or orifices 52 have a length L which represents 20 to 50% of a thickness E of the grid 26 measured in a direction perpendicular to the surface P.

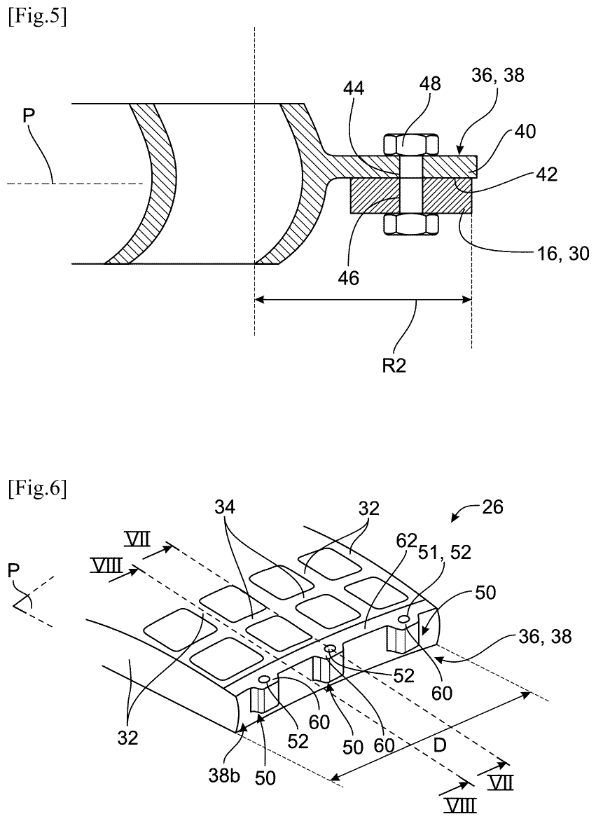

In addition, a comparison of FIGS. 5 and 7 shows that profile 38 has a width R1 that is much smaller than the width R2 of a similar profile in the previous technology.

In the embodiment shown in FIGS. 6 to 8, the tapped hole 51 could be obtained by machining or moulding the grid, for example.

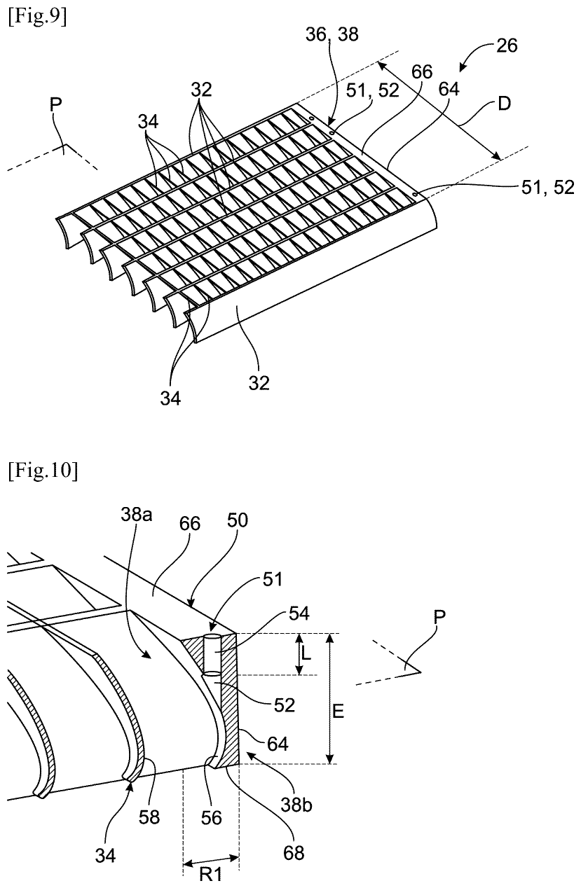

FIGS. 9 and 10 illustrate a variant in which one of the fastening profiles 36, 38, for example the rear profile 38, comprises a single extra thickness 50 comprising at least one tapped hole 51 or in which at least one orifice 52 for mounting a tapped insert 54 is formed.

In the example shown, the extra thickness 50 extends over at least 80% of the length D of the profile, and for example over the entire length of this profile 38. The holes 51 or inserts 54 are oriented perpendicular to the surface P.

The extra thickness is produced in a direction parallel to the surface P.

The profile 38 comprises a first side 38a located inside the aforementioned contour and a second opposite side 38b located outside this contour. The first side 38a has pressure side surfaces 56 which are located opposite suction sides 58 of adjacent vanes 34 and which are separated from each other by spars 32 (FIG. 10).

It can be seen that the second side 38b comprises the single extra thickness 50 and comprises a flat surface 64 which extends over at least 80% of the length D of the profile, and for example over the entire length of the profile 38, and which is perpendicular to the surface P. This flat surface 64 extends between two other flat surfaces, respectively upper 66 and lower 68, which extend over at least 80% of the length D of the profile, and for example over the entire length of the profile 38, and which are parallel to each other and to surface P.

The orifices 52 for mounting the inserts 54 open onto the upper 66 or lower 68 flat surface, which is configured to form a support surface for the grid 26. This bearing surface is designed to cooperate by bearing with the aforementioned frame 16, 30.

FIG. 10 shows that the inserts 54 are fully housed in the orifices 52 and are, for example, each generally tubular in shape. In addition, the orifices 52 for mounting the inserts 54 open onto the pressure side surfaces 56. The orifices 52 are therefore continuous.

The inserts 54 have a length L which represents 20 to 50% of a thickness E of the grid 26 measured in a direction perpendicular to the surface P.

In addition, a comparison of FIGS. 5 and 10 shows that profile 38 has a width R1 that is much smaller than the width R2 of a similar profile in previous technology.

In the event that grid 26 comprises a single hole 51 or a single insert 54, this would preferably be located in the middle or close to the middle of the length D of the profile. In a specific case where this length is around 350 mm, the hole or insert would be located approximately 120 to 175 mm from one side of the grid defined by one of its spars.

In the embodiment shown in FIGS. 9 and 10, the insert 54 could be fastened in its orifice 52 by gluing, screwing, force-fitting or shrinking, for example. Alternatively, it could be directly co-moulded with the grid 26.

The main advantage of the embodiments shown in FIGS. 6 to 10 is that they do not alter the mechanical operation of fastening the grid to the frame. This frame absorbs most of the forces, radially outwards, as the grid is pressed radially against the frame by aerodynamic forces. The main purpose of the screws is to hold the grid in position. Reducing the length of the grid allows for increased radial inertia of the frame, which can help prevent grid deformation.

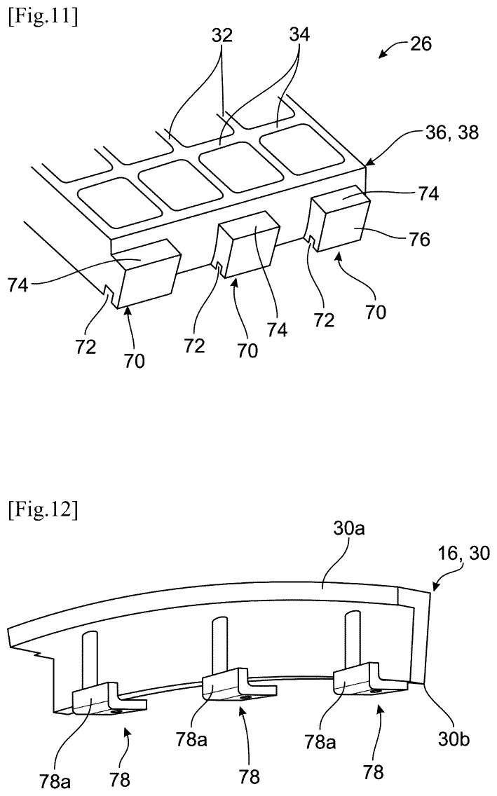

FIGS. 11 to 14 illustrate another variant in which one of the fastening profiles 36, 38, for example the rear profile 38, comprises at least one U-shaped hook 70 which comprises at least one opening 72 oriented perpendicular to the surface P. The or each hook 70 also comprises at least one bearing surface 74 parallel to the surface P.

In the example shown, the profile 38 comprises several U-shaped hooks 70, here three in number, spaced apart from each other.

The bearing surface 74 and the opening 72 of each hook 70 are located on opposite ends of the hook 70. For example, the bearing surface 74 is located on an upper end of the grid 26, and the opening 72 is located on a lower end of the grid 26.

As in the example shown, each hook 70 may have a thickness E1 less than that E2 of the rest of the grid 26.

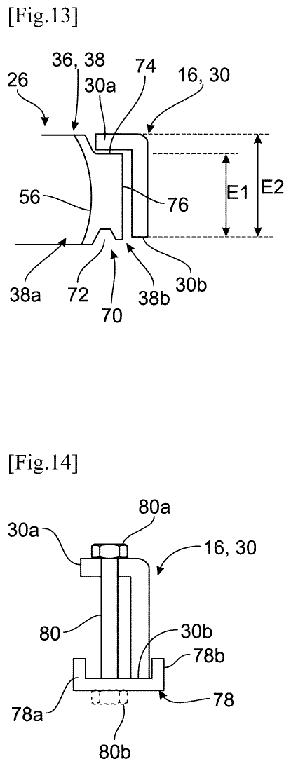

The profile 38 comprises a first side 38a located inside the contour and a second opposite side 38b located outside this contour. The first side 38a has pressure side surfaces 56 which are located opposite suction sides 58 of adjacent vanes 34 and which are separated from each other by spars 32 (FIG. 13).

The second side 38b comprises a flat surface 76 which is perpendicular to surface P. Advantageously, this surface 76 also forms a bearing surface for the grid 26 on the frame to which it is fastened.

FIGS. 12 and 13 show the frame 30 to which the grid 26 is to be fastened. The frame 30 is generally L-shaped in cross-section and comprises a cylindrical rim 30a which extends around the hooks 70. The hooks 70 are supported radially outwards on this rim 30a by their bearing surfaces 74.

FIG. 13 shows that the surface 74 is formed by a step on the grid and that the rim 30a rests on this step and has a thickness that compensates for this step so that the radially outer surface of the rim is aligned with the outer or upper surface of the grid.

FIGS. 12 and 14 show link bars 78 for fastening the grid 26 and in particular the profile 38 to the frame 30.

Each link bar 78 is configured to be mounted on a hook 70 of the grid 26 and is generally U-shaped in the example shown.

Each link bar 78 is applied radially against the lower end of the hook 70 opposite the rim 30a of the frame 30, as well as on an edge 30b of this frame 30 opposite this rim 30a.

Each link bar 78 may comprise a first rim 78a configured to be engaged in the opening 72 of the hook 70. The edge 30b of the frame 30, opposite the rim 30a, can be inserted between the hooks 70 and a second rim 78b of each link bar 78.

Each link bar 78 may comprise a through hole or a screw hole for a screw 80.

The screws 80 extend perpendicularly to the surface P and pass through orifices of the rim 30a of the frame 30 on the one hand, and through orifices in the link bars 78 on the other. Each of these screws 80 can pass through orifices in the hooks 70. Each of the screws 80 comprises a head 80a applied against the rim 30a of the frame 30, and a free end which can be screwed directly into the orifice of the corresponding link bar 78 insofar as this orifice is tapped. Alternatively, a nut 80b can be screwed onto this free end and supported on the link bar 78.

In this variant, each hook 70 has a single opening 72 and a single bearing surface, in this case an upper surface 74.

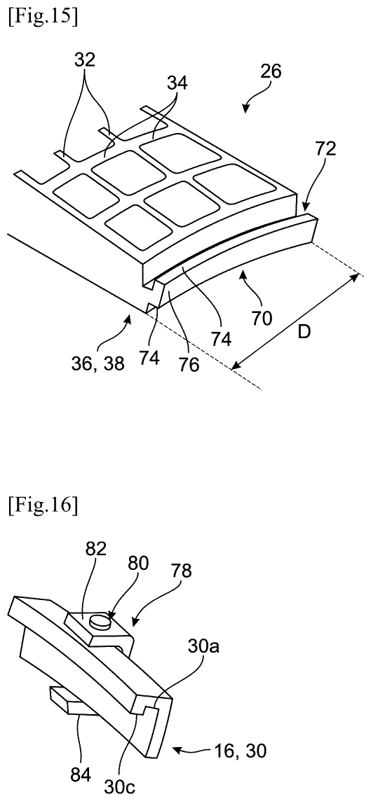

FIGS. 15 to 17 illustrate another variant in which one of the fastening profiles 36, 38, for example the rear profile 38, comprises a single U-shaped hook 70 which comprises an opening 72 oriented perpendicularly to the surface P. This hook 70 also comprises a bearing surface 74 parallel to the surface P.

In the example shown, the U-shaped hook 70 extends over at least 80% of the length D of the profile 38, and for example over the entire length of this profile 38.

The bearing surface 74 and the opening 72 of each hook 70 are located on the same end of the hook 70. For example, the bearing surface 74 is located on an upper end of the grid 26, and the opening 72 is also located on this upper end of the grid 26.

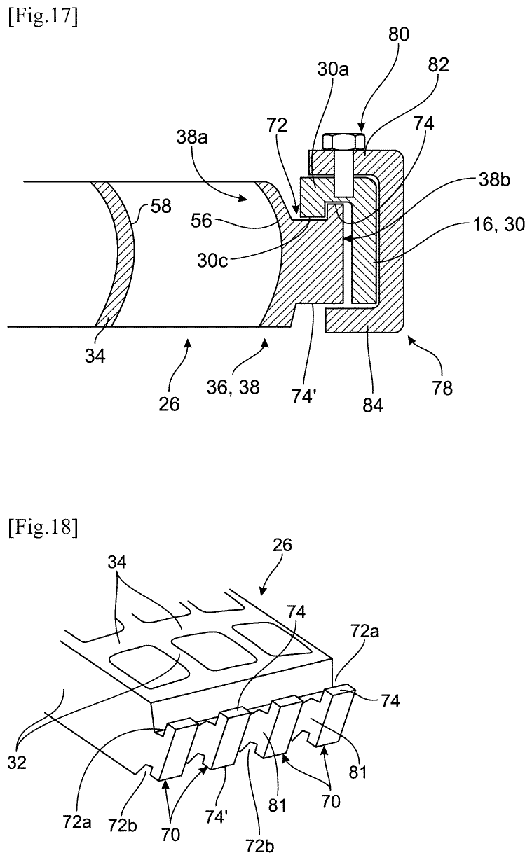

The profile 38 comprises a first side 38a located inside the aforementioned contour and a second opposite side 38b located outside this contour. The first side 38a comprises pressure side surfaces 56 which are located opposite suction side 58 of adjacent vanes 34 and which are separated from each other by spars 32 (FIG. 17).

The second side 38b comprises a flat surface 76 which is perpendicular to the surface P and which extends over at least 80% of the length D of the profile 38, and for example over the entire length of this profile 38. Advantageously, this surface 76 also forms a bearing surface for the grid 26 on the frame to which it is fastened.

FIGS. 16 and 17 show the frame 30 to which the grid 26 is to be fastened. The frame 30 is generally L-shaped in cross-section and comprises a cylindrical rim 30a which extends around the hook 70 and comprises a lug 30c engaged in the opening 72 of the hook 70. The hook 70 is supported radially outwards on this flange 30a by the support surface 74. The lug 30c is engaged in the opening 72 over the full extent of this opening.

FIGS. 16 and 17 also show a link bar 78 for fastening the grid 26 and in particular the profile 38 to the frame 30.

The link bar 78 is generally U-shaped, with the opening oriented in the direction of the surface P of the grid 26.

The link bar 78 is configured to be mounted on the frame 30 and to hold the profile 38 with respect to the frame 30. To achieve this, the link bar 78 comprises two tabs, an upper 82 and a lower 84.

The upper tab 82 of the link bar 78 extends above or radially outside the frame 30 and comprises a passage orifice for a screw 80 which is screwed into a tapped orifice in the frame 30. The screw 80 is oriented perpendicularly to the surface P.

The lower tab 84 of the link bar 78 extends below or radially inside the frame 30 and the hook 70 and thus forms a bearing surface for the hook 70 and therefore the grid 26 radially inwards.

It can thus be understood that, in this embodiment, the hook 70 has a single opening 72 and two bearing surfaces, respectively upper 74 and lower 74′.

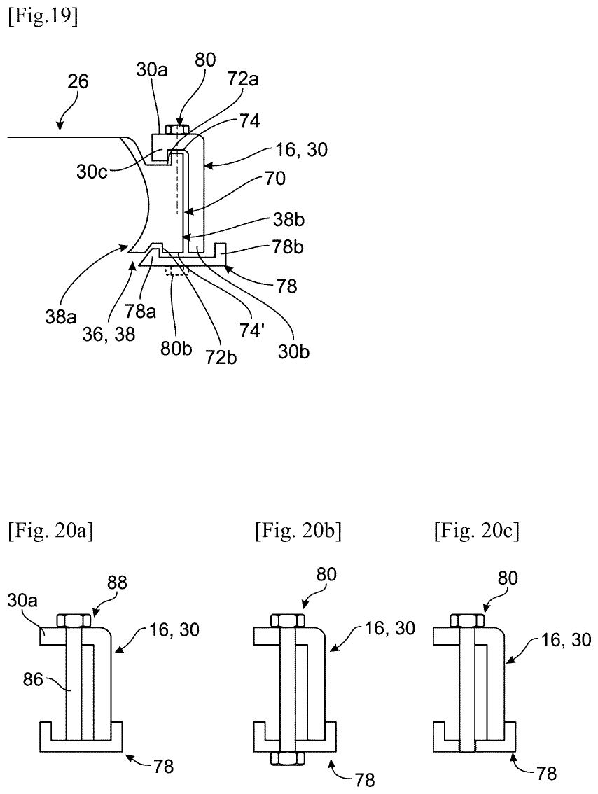

FIGS. 18 and 19 illustrate another embodiment that is similar to that of FIGS. 11 to 14, in which one of the fastening profiles 36, 38, for example the rear profile 38, comprises several U-shaped hooks 70, each of which comprises two openings, an upper opening 72a and a lower opening 72b, which are oriented perpendicularly to the surface P. Each hook 70 further comprises two bearing surfaces, an upper bearing surface 74 and a lower bearing surface 74′, which are parallel to the surface P.

The U-shaped hooks 70 are spaced apart.

The profile 38 comprises a first side 38a located inside the aforementioned contour and a second opposite side 38b located outside this contour. The first side 38a has pressure side surfaces 56 facing suction side 58 of adjacent vanes 34 and separated from each other by spars 32.

The second side 38b comprises a flat surface 76 which is perpendicular to surface P. Advantageously, this surface 76 also forms a bearing surface for the grid 26 on the frame to which it is fastened.

FIG. 19 shows the frame 30 and the link bar 78 used to fasten the grid 26 in the FIG. 18. The frame 30 is generally L-shaped in cross-section and comprises a cylindrical rim 30a which extends around the hooks 70. The hooks 70 are supported radially outwards on this rim 30a by their bearing surfaces 74. The cylindrical rim 30a comprises a first lug 30c which engages in the upper opening 72a of each of the hooks 70.

FIG. 19 also shows a link bar 78 mounted on the hooks 70 of the grid 26.

Each link bar 78 is configured to be mounted under a hook 70 of the grid 26 and is generally U-shaped in the example shown.

Each link bar 78 is applied radially against the lower surface 74′ of the hook 70 opposite the rim 30a of the frame 30, as well as on an edge 30b of this frame 30 opposite this rim 30a.

Each link bar 78 may comprise a first rim 78a configured to be engaged in the opening 72b of the hook 70. The edge 30b of the frame 30, opposite the rim 30a, can be inserted between the hooks 70 and a second rim 78b of each link bar 78.

Each link bar 78 may comprise a passage or a screwing orifice for a screw 80.

The screws 80 extend perpendicularly to the surface P and pass through orifices of the rim 30a of the frame 30 on the one hand, and through orifices in the link bars 78 on the other. Each of these screws 80 can be housed in transverse spaces 81 between hooks 70.

Each of the screws 80 comprises a head 80a applied against the rim 30a of the frame 30, and a free end which can be screwed directly into the orifice of the corresponding link bar 78 insofar as this orifice is tapped. Alternatively, a nut 80b can be screwed onto this free end and supported on the link bar 78.

In this variant, each hook 70 has two openings 72a, 72b and two bearing surfaces, upper 74 and lower 74′ respectively.

FIGS. 20a to 20c show alternative versions of the frame 16, 30 and link bar(s) 78.

In the case of FIG. 20a, the or each link bar 78 has a general U-shape similar to that of FIGS. 14 and 19 and is secured to at least one threaded rod 86 which extends perpendicularly to the surface P. This rod 86 is intended to pass through the orifice in the cylindrical rim 30a of the frame 30 and its free end is intended to receive a nut 88. Advantageously, this nut 88 is captively mounted on the frame 30.

FIG. 20b corresponds to the embodiment shown in FIGS. 14 and 19, with the free end of screw 80 screwed directly into a nut.

FIG. 20c corresponds to the design shown in FIGS. 14 and 19, with the free end of screw 80 screwed directly into a tapped orifice in the link bar 78.

In the embodiments shown in FIGS. 11 to 20c, the tapped holes can be obtained by machining, moulding or co-moulding. Alternatively, they could be obtained by inserts which would be housed and held in orifices by gluing, screwing, force-fitting or shrink-fitting, for example.

The main advantage of the methods shown in FIGS. 11 to 20c is that they do not alter the mechanical operation of fastening the grid to the frame. This frame absorbs most of the forces, radially outwards, as the grid is pressed radially against the frame by aerodynamic forces. The main purpose of the screws is to hold the grid in position. Reducing the length of the grid allows for increased radial inertia of the frame, which can help prevent grid deformation.

FIGS. 21 to 23 illustrate another variant in which one of the fastening profiles 36, 38, for example the front profile 36, comprises at least two hinge clevises 90 extending longitudinally from side members 32 and each comprising an orifice 92. The orifices 92 in the clevises 90 are aligned or ball-jointed and define pivot points for the grid 26. In one configuration, the clevises 90 can be parallel to each other, which can promote rotation about the same axis A.

Advantageously, the clevises 90 extend as an extension of spars 32 and can be formed by the ends of these spars 32. This distributes the forces of the grid 26 over the spars 32.

The clevises 90 here are single-ear clevises.

The clevises 90 are formed in one piece with the rest of the grid 26, but could alternatively be added and fastened to the rest of the grid.

Metal bushings can be housed in the orifices 92 in the clevises 90.

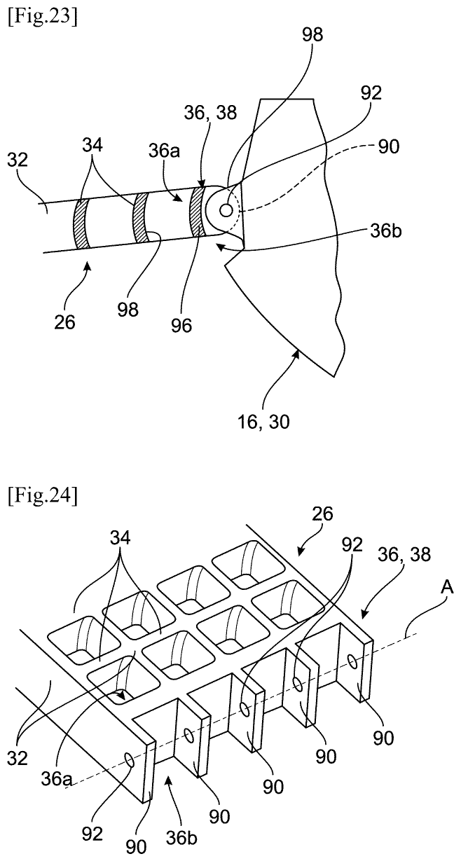

The profile 36 comprises a first side 36a located inside the aforementioned contour and a second opposite side 36b located outside this contour. The first side 36a comprises suction side surfaces 94 which are located opposite pressure side 96 of adjacent vanes 34 and which are separated from each other by spars 32. The second side 36b, which comprises the forks 90 and may have a generally rounded concave shape, as shown in FIG. 23.

In the example shown, each of the clevises 90 has a rounded peripheral contour.

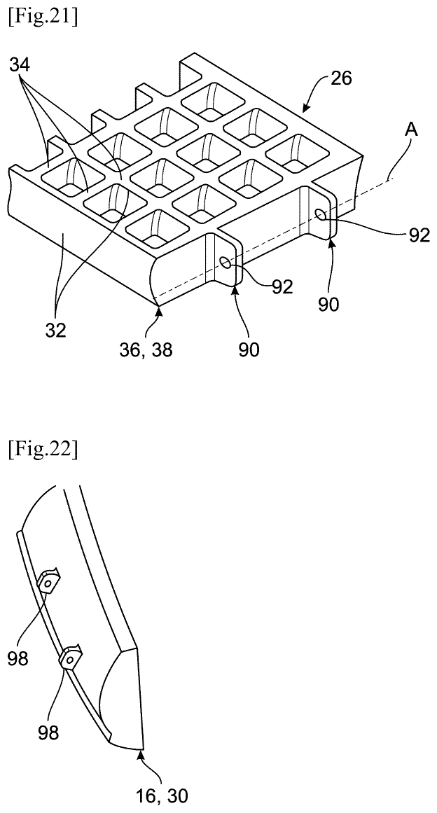

FIGS. 21 and 22 show the frame 16 to which the clevises 90 are fastened and in particular articulated. The frame 16 also includes complementary clevises 98 for fastening the clevises 90 of the grid 26. The number of clevises 98 on the frame 16 is equal to the number of clevises 90 on the grid 26 and is two in the example shown. Each of the clevises 98 has a rounded peripheral contour. Pins pass through the orifices in the clevises 90 and 98 respectively to allow them to pivot.

The clevises can be machined or moulded in the mass, or added and fastened to the frame 16.

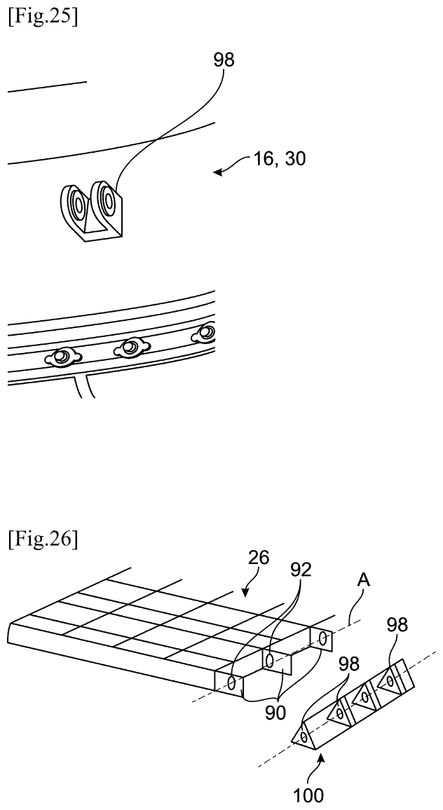

FIGS. 24 and 25 illustrate another variant in which one of the fastening profiles 36, 38, for example the front profile 36, comprises more than two hinge clevises 90 which are parallel to each other and to the spars 32 and which each comprise an orifice 92. The orifices 92 in the clevises 90 are aligned and define a pivot axis A for the grid 26.

The number of clevises 90 is, for example, between two and eight. The number of clevises 90 is equal to the number of side members 32 in the example shown.

Advantageously, the clevises 90 extend as an extension of the spars 32 and can be formed by the ends of these spars 32. This distributes the forces of the grid 26 over all the spars 32.

The clevises 90 here are single-ear clevises.

The clevises 90 are formed in one-part with the rest of the grid 26, but could alternatively be added and fastened to the rest of the grid.

Metal bushings can be housed in the orifices 92 in the clevises 90.

The profile 36 comprises a first side 36a located inside the aforementioned contour and a second opposite side 36b located outside this contour. The first side 36a comprises suction side surfaces 94 which are located opposite pressure side 96 of adjacent vanes 34 and which are separated from each other by spars 32. The second side, 36b, comprises the clevises 90 and may have a generally rounded, concave shape.

In the example shown, each of the clevises 90 has a square or rectangular peripheral contour.

FIG. 25 shows the frame 16 to which the clevises 90 are fastened and in particular articulated. The frame 16 also includes complementary clevises 98 for fastening the clevises 90 of the grid 26. These clevises 98 are double-ear, which facilitates the transfer of transverse forces. The two ears of each clevis 98 define a mounting space for the corresponding clevis 90. Each of the clevises 98 can have a rounded peripheral contour. Pins pass through the orifices in the clevises 90 and 98 respectively to allow them to pivot.

The clevises can be machined or moulded in the mass, or added and fastened to the frame 16.

FIG. 26 illustrates another variant which is similar to the variants shown in FIGS. 21 to 25. In this variant, the clevises 98 on the frame 16 are supported by a fitting 100 which is added and fastened to the frame 16.

The embodiments shown in FIGS. 21 to 26 have the particular advantage of creating a pivot connection between the grid and its fastening frame. This change simplifies the construction of the grid, as it is not necessary to tighten any fastening elements; instead, only the pivot pins of the clevises need to be installed and secured in position (e.g., with pins, nuts, etc.).

1. A jet deflection module for a thrust reverser of an aircraft turbomachine, this module extending in a surface and comprising:
spars which are spaced apart and parallel to each other,
at least one deflection element which extends between the spars and is connected to these spars,
two fastening profiles, front and rear respectively, which are connected to the spars, these two profiles forming with two of these spars a peripheral contour of the module,
characterized in that a first of the fastening profiles comprises several hooks at a distance from one another, each of these hooks comprising at least one opening oriented perpendicularly to said surface and also a bearing surface parallel to this surface.

2. The module according to claim 1, wherein said the bearing surface and the opening of each hook are located on the same end of this hook, or respectively on two opposite ends of this hook.

3. The module according to claim 1, wherein each hook comprises two openings oriented perpendicularly to said surface and in opposite directions.

4. The module according to claim 1, wherein said first profile comprises a first side located inside said contour and a second opposite side located outside this contour, the first side comprising pressure side surfaces, the second side comprising the hook or hooks.

5. The module according to claim 1, wherein each hook comprises a flat surface which is located outside said contour and which is perpendicular to said surface.

6. The module according to claim 1, wherein said first profile is the rear profile of the module.

7. The module according to claim 1, wherein this module is a grid comprising several spars and vanes which extend between the spars and which are connected to these spars, these vanes being perpendicular to the spars.

8. The module according to claim 1, wherein the fastening profiles are perpendicular to the spars.

9. The module according to claim 1, wherein each of the hooks is U-shaped.

10. The module according to claim 1, wherein each hook has a thickness less than that of the module.

11. The module according to claim 1, wherein said deflection element is a vane.

12. The module according to claim 1, wherein it is made of composite material.

13. The assembly comprising a module according to claim 1 and at least one link bar for fastening the module, the or each link bar having a general L or U shape and being configured so as to be mounted on the hook of the module.

14. A thrust reverser for an aircraft turbomachine, comprising at least one module according to claim 1 or an assembly having at least one link bar for fastening the module, the or each link bar having a general L or U shape and being configured so as to be mounted on the hook of the module.

15. An aircraft turbomachine, comprising a module according to claim 1, an assembly having at least one link bar for fastening the module, the or each link bar having a general L or U shape and being configured so as to be mounted on the hook of the module or a thrust reverser having at least one link bar for fastening the module, the or each link bar having a general L or U shape and being configured so as to be mounted on the hook of the module.
